(19) United States
(12) Patent Application Publication
(10) Pub. No.: US 2004/0093448 A1
(43) Pub. Date: May 13, 2004

(54) Multi-functional optical disk driving device

(75) Inventors: Kuo Chuan Wu, Taipei (TW); Tun Jen Chen, Taipei (TW); Chin Chuang Hsiao, Tucheng City (TW); Shin Shin Chu, Banciao City (TW)

Correspondence Address: BUCKNAM AND ARCHER, 1077 Northern Boulevard, Roslyn, NY, 11576-1696, US

(73) Assignee: ASOUR TECHNOLOGY INC.

(21) Appl. No.: 10/702,304

(22) Filed: Nov. 6, 2003

(30) Foreign Application Priority Data
Nov. 8, 2002 (TW) 091132882
Jul. 28, 2003 (TW) 092120503
Oct. 28, 2003 (TW) 09219900

(51) Int. Cl. G06F 13/12

(52) U.S. Cl. 710/72

(57) ABSTRACT

The invention relates to a multi-functional optical disk driving device used in personal computer (PC), which has functions of a compact-disk (CD) driver, a digital versatile disk (DVD) driver, a frequency modulated (FM) radio, a MP3 music CD player, such device comprises: a multi-functional vision process controller (VPC) having a PC power on status detector; a microprocessor; a bus switch; an optical disk server; and a connecting device. The multi-functional optical disk driving device of present invention is characterized in that the device can perform these functions without making use the control from the operating system (OS) of a personal computer even if the PC is off and these functions are performed by the PC when the PC is on. The connecting device having a POWER connector, a DVD-ROM CD-DA ANALOG AUDIO OUTPUT connector, and a SPDIF (Sony-Philips Digital Interface) connector, wherein the connecting device includes a dominator connector, the dominator connector having a control bus and an output bus, by which the extensibility of the optical disk driving device can be increased.

### BACKGROUND

1. Field of the Invention

The present invention relates to a multi-functional optical disk driving device and connecting device thereof, especially to a personal computer equipped with functions of compact-disk (CD) driver, digital versatile disk (DVD) driver, frequency-modulated (FM) radio, and a MP3 music CD player, in which the optical disk driving device can perform various functions independent without operating system (OS) of computer when the personal compute (PC) is off, and a connecting device.

2. Related art of the Invention

In general, an optical compact-disk driver used in personal computer is a storage device for reading and writing data in optical manner. In fact, the optical disk driver is the most important technology achieved in field of data storage after the invention of magnetic diskette driver. The optical disk driver has combined the advantage of large storage capacity of a high density magnetic tape and the rapid random access of a diskette driver with series of superior performance such as high recording density, large storage capacity, read/write in non-contact mode, ease in disk replacement, high data transmission speed, randomly and fast accessible, long preservation time only stored information, low cost for each information stored therein. Such high-precision technology has intensively applied to industrial divisions such as television, audio equipment, image storage and data processing units.

Recently, personal computer (PC) has become a popular personal data processing device, and the optical disk driver installed thereon has played a very important role. However, when the personal computer is not in use, the optical disk driver is also left unused, while it is rather inconvenient that one have to add a digital versatile disk driver to watch the contents of disk, to use a radio to listen to the broadcasting of a FM radio station, to turn on the computer in order to receive and play the sound music of a MP3 music optical compact-disk player.

Therefore, it is truly necessary to develop a device, on one hand, capable of achieving the efficacy of saving space, increasing convenience, and reducing cost without turning on the personal computer and making use the operating system of the personal computer, while on the other hand, capable of being integrated in an unit for an optical compact-disk driver to play a video compact disk, a digital versatile disk driver to play a digital versatile disk, a frequency-modulated radio to play a frequency-modulated broadcasting, and an optical compact-disk player of MP3 music to play a music stored thereon.

Moreover, because the configuration of connecting device of an optical disk driving device is currently restricted to a standard criterion of ATAPI (AT Attachment Packet Interface) for CD-ROMs SFF-8020i., the usable space is filled with POWER connector, CD-DA ANALOG AUDIO OUTPUT connector, and IDE (Integrated Dual-channel Enhanced) or SCSI (Small Computer System Interface) connector or SPDIF (Sony-Philips Digital Interface) connector, and is impossible for further extension, For example, as shown in FIG. 5, the connecting device for the conventional optical disk driving device has simply a POWER connector 41, AUDIO connector 39 and IDE or SCSI connector 40 of traditionally standard configuration, and is difficult for the further extension.

Therefore, it is necessary for development of a connecting device having a bus corresponding to control or input/output of an optical disk driving device, thereby to improve the extensibility of the optical disk driving device.

### SUMMARY OF THE INVENTION

Based on the above issues, an object of the present invention is to provide a multi-functional optical disk driving device having functions of a compact-disk (CD) driver, a digital versatile disk (DVD) driver, a frequency modulated (FM) radio, and a MP3 music CD player, with which one can perform various functions independent without making use the control from the operating system (OS) of a personal computer even if the PC is off.

Further, another object of the present invention is to provide a connecting device for a multi-functional optical disk driving device having functions of a compact-disk (CD) driver, a digital versatile disk (DVD) driver, a frequency modulated (FM) radio, and a MP3 music CD player, with which one can perform various functions independent without making use the control from the operating system (OS) of a personal computer even if the PC is off, the connecting device comprising a dominator connector, the dominator connector combining preserved interfaces of control bus and input/output bus with CD-DA ANALOG AUDIO OUTPUT connector and SPDIF (Sony-Philips Digital Interface) connector, by which the extensibility of the optical disk driving device can be improved so as to derive an unlimited space for the future extension.

To achieve the one object, according to one aspect of the present invention, a multi-functional optical disk driving device is provided. The multi-functional optical disk driving device is used for a personal computer (PC) and has functions of a compact-disk (CD) driver, a digital versatile disk (DVD) driver, a frequency modulated (FM) radio, MP3 music CD player, the multi-functional optical disk driving device comprising: a multi-functional vision process controller (VPC) having a PC power on status detector; an optical disk server; a bus switch, connected between standard interfaces of the PC and the optical disk server; and a microprocessor, for control of on/off of the bus switch. The multi-functional optical disk driving device of the present invention is characterized in that the Vision process controller (VPC) can disconnect the standard interfaces between the PC and the optical disk server by means of controlling the bus switch via said microprocessor when the PC is off, and the microprocessor performs the above functions independent; and the microprocessor controls the bus switch to connect the standard interfaces between the PC and the optical disk server when an PC power on state is detected by the PC power on status detector and the above functions are performed by the PC.

Further, in accordance with the above aspect of the present invention, the personal computer (PC) includes Table Top PC, Notebook PC, and Tablet PC.

Further, in accordance with the above aspect of the present invention, the standard interface includes ATAPI-IDE or serial ATA, and USB 1.1/2.0 and IEEE 1394 standard interfaces for internally or externally connecting to a personal computer.

Still further, in accordance with the above aspect of the present invention, the optical disk server includes CD-ROM, DVD-ROM, DVD−R, DVD−RW, DVD+R, DVD+RW, and DVD-RAM servers.

Furthermore, in accordance with the above aspect of the present invention, it is provided on the panel of the optical disk driving device with functions of mode selection, adjustment control and status indication.

Further, in accordance with the above aspect of present invention, the PC-power status detector is used to detect the voltage of a power supply unit in the personal computer or the reset signal of host computer received from a bus which is connected between the personal computer and the vision process controller, so as to determine the power-on status of the personal computer.

Moreover, to achieve the another object of the present invention, according to another aspect of the present invention, a connecting device for multi-functional optical disk driving device is provided, the multi-functional optical disk driving device having functions of a compact-disk (CD) driver, a digital versatile disk (DVD) driver, a frequency modulated (FM) radio, and a MP3 music CD player, the connecting device having a POWER connector; a CD-DA ANALOG AUDIO OUTPUT connector and a SPDIF (Sony-Philips Digital Interface) connector the characteristics of the connecting device comprising a dominator connector, the dominator connector having a control bus and an output bus, by which the extensibility of the optical disk driving device can be increased.

### BRIEF DESCRIPTION OF THE DRAWINGS

The above and other objects, features, and advantages of present invention will become more apparent from the detailed description in conjunction with the accompanying drawings, where identical reference number indicates similar parts:

FIG. 1 is a block diagram showing schematically a system structure of a preferred embodiment of the present invention.

FIG. 2 is a circuit diagram showing a circuit structure of a PC power on status detector in accordance with the present invention.

FIG. 3 is a flow chart illustrating the operation procedure of a multi-functional optical disk driving device in accordance with the present invention.

FIG. 4 is a schematic view showing the appearance of a product in accordance with the preferred embodiment of the present invention.

FIG. 5 is a schematic structural diagram illustrating a conventional connecting device of an optical disk driving device.

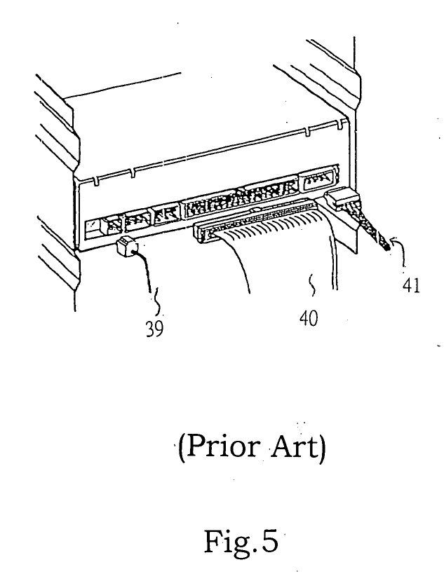

FIG. 6 is a schematic view showing the appearance of a connecting device of an optical disk driving device in accordance with another preferred embodiment of the present invention.

FIG. 7 is a schematic structural diagram illustrating a connecting device of an optical disk driving device in accordance with the preferred embodiment of the present invention.

FIG. 8 is a block diagram showing schematically a system structure of another preferred embodiment of the present invention.

### DETAILED DESCRIPTION OF THE INVENTION

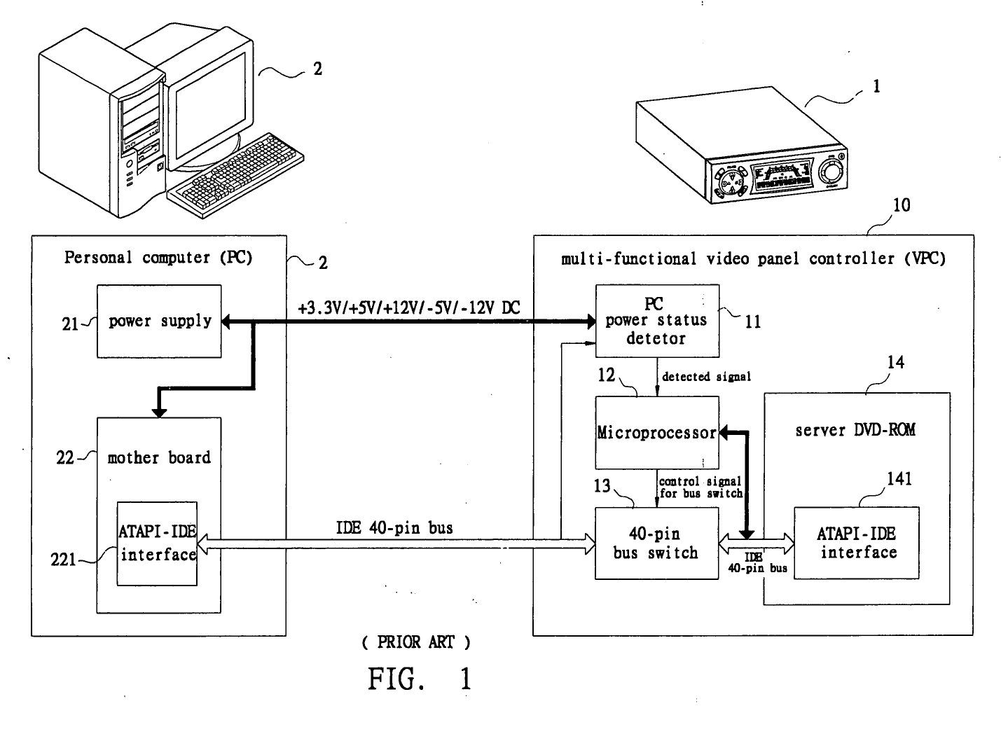

Referring to FIG. 1, which is a block diagram showing schematically a system structure of a preferred embodiment of the present invention. In FIG. 1, a multi-functional optical disk driving device 1 used in a personal computer (PC) 2 including integrally a compact-disk (CD) driver, a digital versatile disk (DVD) driver, a frequency modulated (FM) radio, a MP3 music CD player is provided. In general, the multi-functional optical disk driving device 1 comprises: a PC power on status detector 11 connected to a power supply 21 of the personal computer 2; a microprocessor 12 for controlling a 40-pins bus switch 13; and an optical disk server 14, the optical disk server (also referred as optical storage device server) 14 having ATAPI-IDE (AT application program interface-integrated driving electronics) interface 141 which is connected to ATAPI-IDE interface 221 interface in the mother board 22 of the personal computer 2 via the 40-pins bus switch 13. However, the present invention is not restricted to the above described bus switch and interface but can be any bus switch and interface which is suitable for internally or eternally connecting PC with the optical disk driving device, such as serial ATA, USB 1.1/2.0 and IEEE 1394 bus switches and interfaces, which will be described later. Herein, the optical disk server 14 is a DVD-ROM server. However, the present invention is not limited to this kind of sever, which will also be described later.

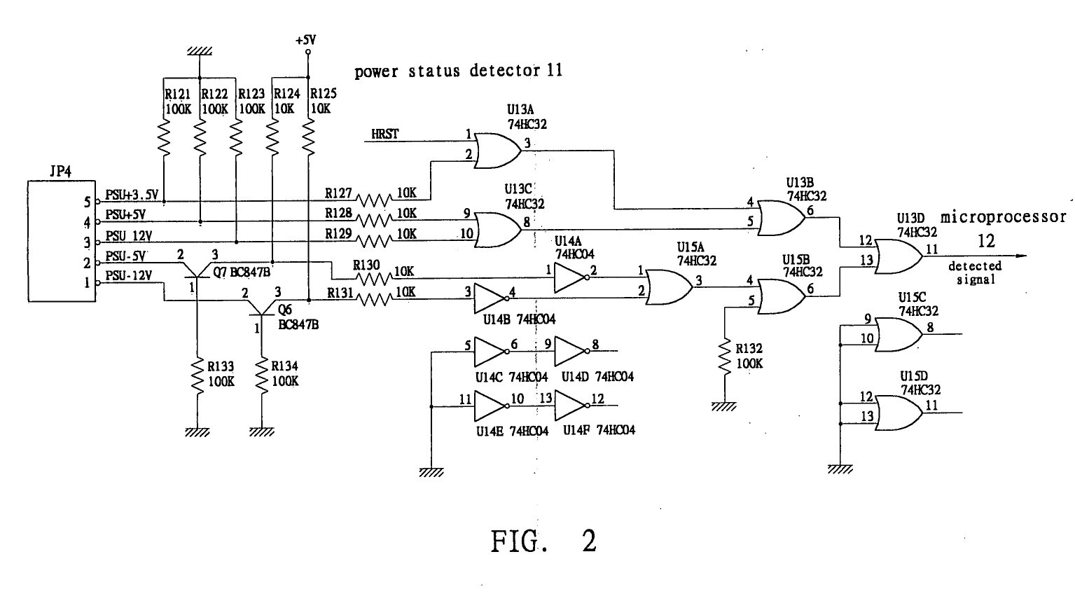

FIG. 2 shows the circuit structure diagram of the PC power on status detector 11 in accordance with the present invention. The PC power on status detector 11 is connected to the power supply unit 21 of the personal computer (PC) 2 for detecting whether there is a working voltage presented on the personal computer or not, and is connected to the ATAPI-IDE interface of the personal computer for detecting whether there is a HRST (host computer reset signal) presented; when one of these two is present, it indicates that the personal computer is turned on and when both of them are absent, it indicates the personal computer is turned off. The PC power on status detector 11 will send a detection signal to the microprocessor 12 to control the ON/OFF of the 40-pin bus switch 13 when an on-status of the personal computer is detected.

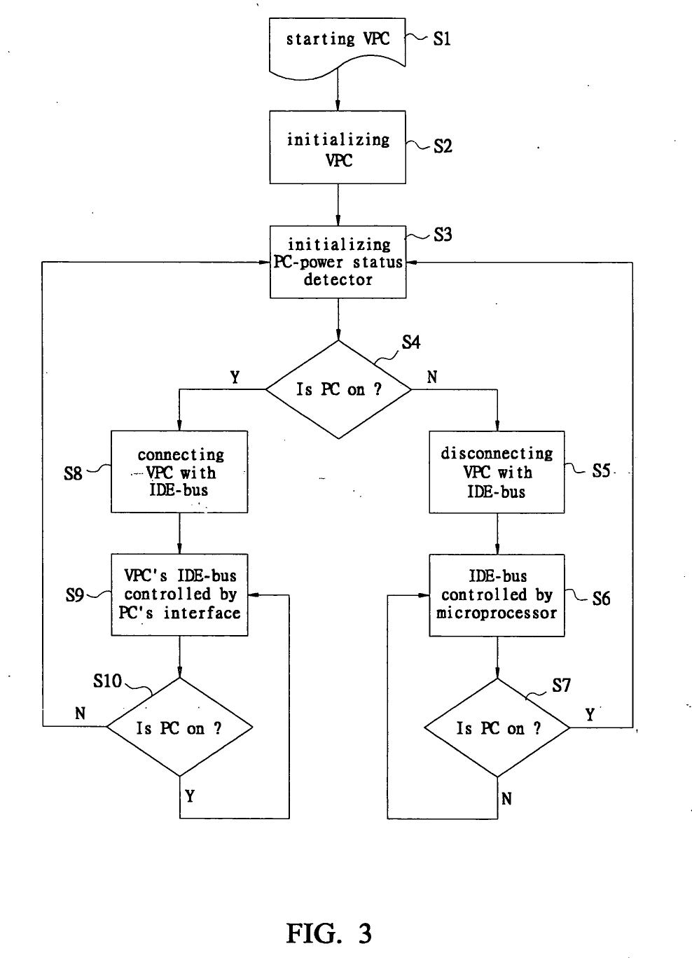

FIG. 3 is a flow chart showing the operation procedure of a multi-functional optical disk driving device in accordance with the present invention. As shown in the figure, in step S1, starting to operate the multi-functional vision process controller (VPC) 10 of the optical disk driving device 1; firstly in step S2, initializing the multi-functional vision process controller (VPC) 10; in step S3, initializing a PC power on status detector 11 inside the multi-functional vision process controller (VPC) 10 and proceeding to step S4; in step S4, the PC-power status detector 11 will verify whether the personal computer (PC) 2 is turned on or off by detecting the existence of DC voltage, for example the voltages of +3.3V/+5V/+12V/−5V/−12V, on the power supply unit 21 of the personal computer 2, and the existence of host computer reset signal (HRST) on the IDE bus (i.e., directly connected between the IDE-pertained mother board of a personal computer and a IDE-driver-pertained optical compact-disk driver), when the personal computer is off, that is to say, no voltage or HRST signal is detected, the operation will proceed to step S5, and when the personal computer is on, i.e. voltage or HRST signal is detected, the operation will proceed to step S8; in step S5, the PC power on status detector 11 will send a detection signal indicating the personal computer 2 is off to the microprocessor 12, so that the microprocessor 12 can control a 40-pins bus switch 13 to disconnect the multi-functional vision process controller (VPC) 10 and the IDE bus on the mother board 22 of the personal computer 2; then in step S6, controlling the IDE bus by means of the microprocessor 12 of the multi-functional vision process controller (VPC) 10; followed in step S7, the PC power on status detector 11 will continue to detect whether the personal computer 2 is on or not, if the personal computer 2 is still off, the operation will return to step S6 and allow the microprocessor of the VPC to continue the control of the IDE bus, while if the personal computer is now on, the operation will then return to step S3; after that if the personal computer is on in step S4, the operation will proceed to step S8; in step S8, the PC power on status detector 11 will send a detection signal indicating the personal computer 2 is on to the microprocessor 12, so that the microprocessor 12 can control a 40-pin bus switch 13 to connect the multi-functional vision process controller (VPC) 10 and the IDE bus on the mother board 22 of the personal computer 2; then in step S9, controlling the IDE bus by means of an ATAPI-IDE interface 221 of a personal computer; followed by step S10, the PC power status detector 11 will continue to detect whether or not the personal computer 2 is on, if the personal computer 2 is on, the operation will return to step S9 and allow the ATAPI-IDE interface 221 of the personal computer to continue the control of the IDE bus of the VPC, while if the personal computer is now off, the operation will then return to step S3.

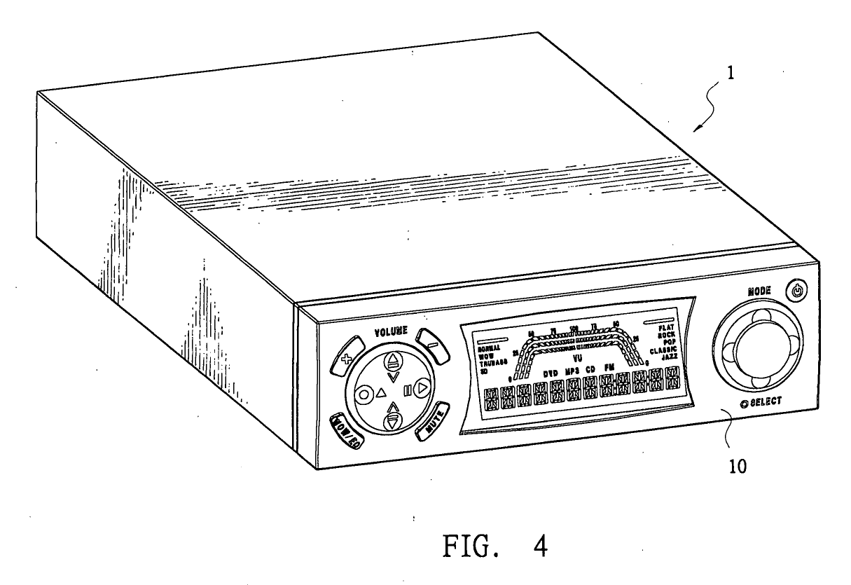

FIG. 4 is a schematic view illustrating the appearance of a product in accordance with above preferred embodiment of the present invention. As mentioned above, the present invention combines a digital versatile disk (DVD) driver, a MP3 music CD player, a compact-disk (CD) driver, a frequency modulated (FM) radio into a single device in a personal computer that is used as an optical disk driver when the PC is on, even if the PC is off such a device can operate independently without going through the operating system of the PC. The device of the present invention has gathered the controlling means of function, mode, adjustment and selection in a four-way selector located at the left side of the panel and a shuttle button located at the right side of the panel, while displaying the information about its state of usage on the central part of the panel in the vacuum fluorescent display.

As shown in the figure, the optical disk driving device 1 is a thin rectangular cassette body with its longitudinal depth greater than it front width, its front face include a retrievable vision process controller 10 having a circular protruded four-way selector provided on its left side. On the surface of the four-way selector, options of forward/play/backward/stop are provided at positions 12, 3, 6, and 9 o'clock respectively; while on the circumference of the four-way selector, four functional keys of volume-down/mute/WOW & EQ/volume-up with a shape of equivalent span recessed on the axial periphery are provided at positions 2, 4, 8, and 10 o'clock. On the right side of the panel, there is provided with a circular double-protruding shuttle button composed of a center button and a surrounding rotation button; the tip of the center button is a spherical shaped mode selecting button, while the hemispherical protruded periphery rotating button located at surface positions such as 12, 3, 6 and 9 o'clock positions are used to adjust frequency/play-back speed via clockwise/counterclockwise rotation; and on the upper right corner, there is provided with a spherical push button for controlling the ejection/retrieving of the control panel. At the center of the panel, transversal lengthened vacuum fluorescent display with its upper and lower edges shaped into slightly convex arc and with it left and right edges shaped into slightly concave arc is provided, the surface of the vacuum fluorescent display will then display information such as frequency response selection/power output table/tune selection/selective indication in accordance with the controlling modes of the four-way selector and shuttle button.

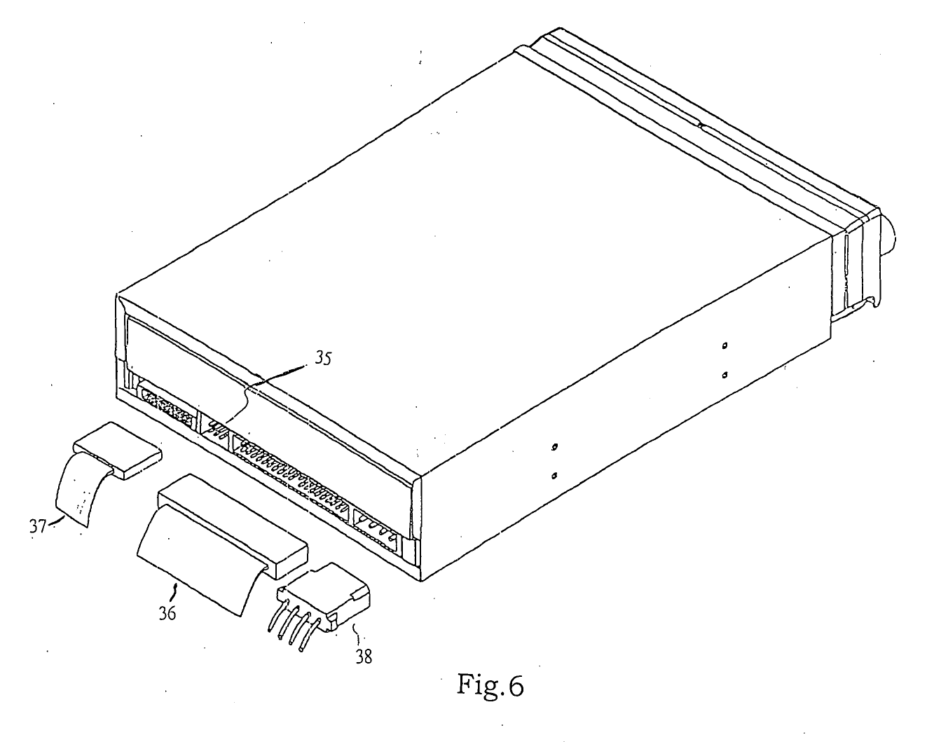

FIG. 6 is a schematic view showing the appearance of a connecting device of an optical disk driving device in accordance with another preferred embodiment of the present invention. In FIG. 6, a connecting device for multi-functional optical disk driving device is shown, the multi-functional optical disk driving device having functions of a compact-disk (CD) driver, a digital versatile disk (DVD) driver, a frequency modulated (FM) radio, and a MP3 music CD player disposed inside integrally. The connecting device has a POWER connector 38, a CD-DA ANALOG AUDIO OUTPUT connector 35, and a SPDIF (Sony-Philips Digital Interface) connector 36. The characteristics of the connecting device comprises a dominator connector 37. The dominator connector 37 has a control bus and an output bus, thereby the extensibility of the optical disk driving device can be increased.

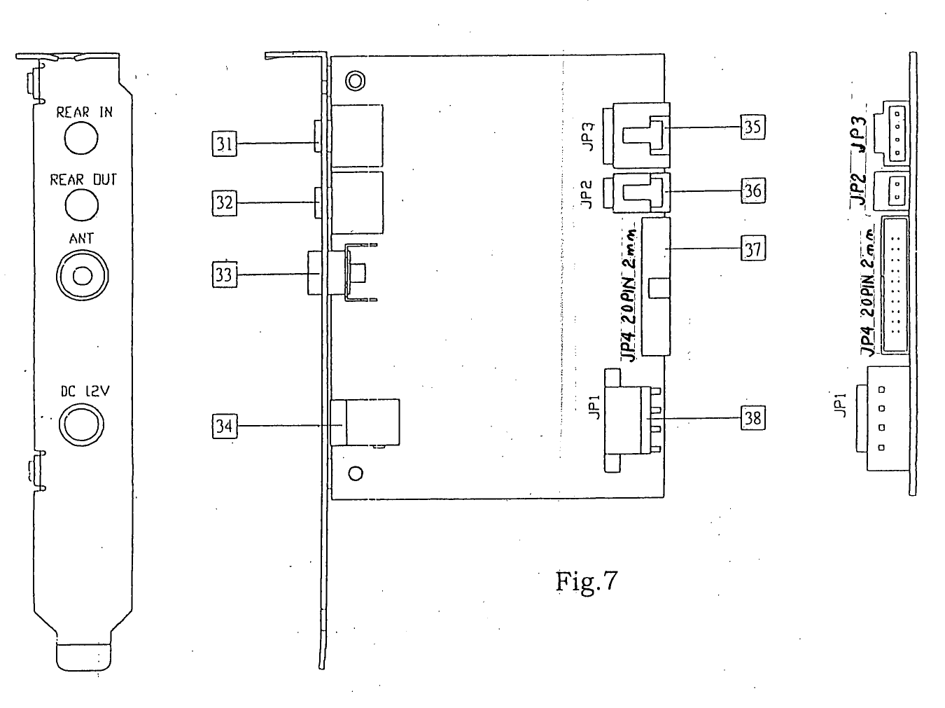

FIG. 7 is a schematic structural diagram illustrating a connecting device of an optical disk driving device in accordance with the preferred embodiment of the present invention. In FIG. 7, a connecting board of optical disk driving device for connection with the personal computer is shown. On the left side of the connecting board, there are provided with a POWER connector 38, a CD-DA ANALOG AUDIO OUTPUT connector 35, a SPDIF OUTPUT connector 36, and a DOMINATOR connector 37. The DOMINATOR 37 connector has a CONTROL bus and an INPUT/OUTPUT bus (not shown). On the right side of the connecting board, there are provided with a rear input 31, a rear output 32, FM antenna 33, and a DC 12 volts input 34.

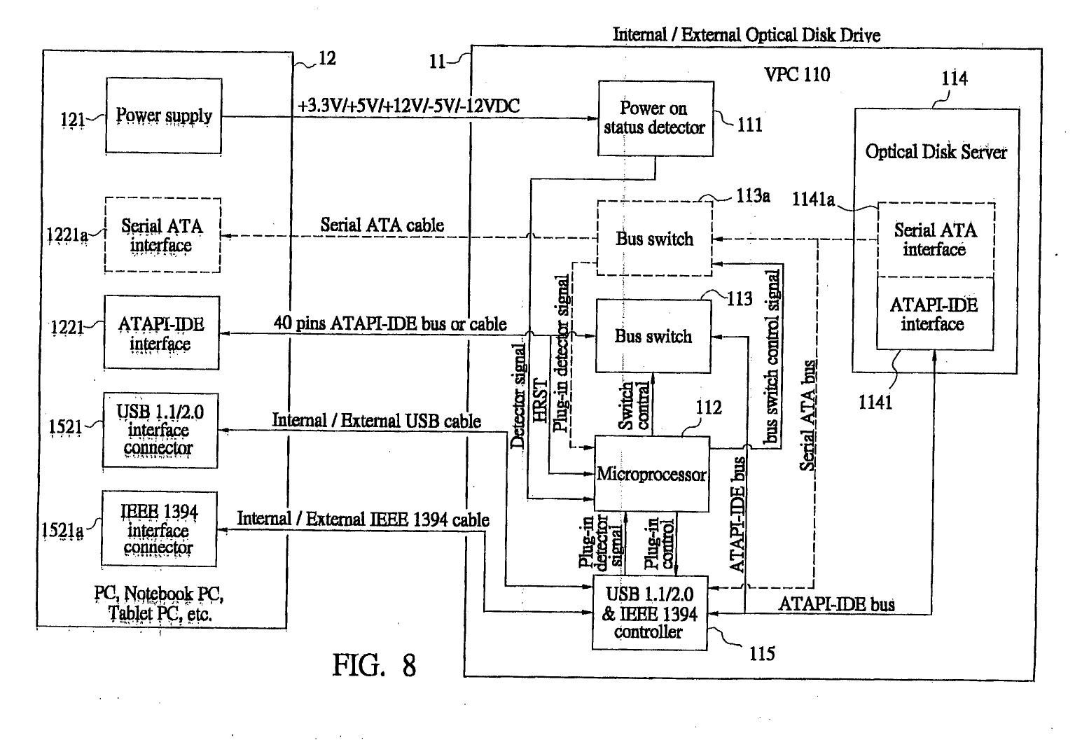

In addition, as shown is FIG. 8, which is a block diagram showing schematically a system structure of another preferred embodiment of the present invention. For simplicity, the description of the portion in FIG. 8 which is similar to that shown in FIG. 1 will be omitted here. The function of VPC 10, as shown in FIG. 1, can be enhanced in the configuration of FIG. 8. As shown in FIG. 8, a multi-functional optical disk driving device 11 has a PC power on status detector 111, connected to a power supply 121 of a personal computer 12; a microprocessor 112, for controlling a 40-pins bus switch 113 and a serial bus switch 113a; an optical disk drive 114, having an ATAPI-IDE interface 1141 and a serial ATA interface 1141a; and an USB 1.1/2.0 and IEEE 1394 controller 115. Among others, the 40-pins bus switch 113 and the serial bus switch 113a are respectively connected to ATAPI-IDE interface 1221 and serial ATA interface 1221 a in a 40-pins ATAPI-IDE bus or cable and a serial ATA interface cable. The USB 1.1/2.0 & IEEE1394-controller 115 is connected to USB 1.1/2.0 interface connector 1521 and IEEE 1394 interface connector 1521a in USB cable and IEEE 1394 cable, respectively.

As described above, according to the configuration of FIG. 8, the personal computer (PC) 12 may further include a Notebook PC and a Tablet PC, except the ordinary Table Top PC. In other words, the VPC 110 can be extensively employed for any of above described PCs.

As described above, according to the configuration of FIG. 8, the optical disk server 114 is not restricted to the DVD-ROM server which is typically used in the system of FIG. 1, but can be including any one of CD-ROM, DVD-ROM, DVD−R, DVD−RW, DVD+R, DVD+RW, and DVD-RAM servers, and so on. As shown schematically, the connecting interface of the optical disk server 114 can be ATAPI-IDE interface 1141 and serial ATA interface 1141a which can automatically detect if the bus is plugged in. The VPC 110 can be set as automatic connection or manual connection with the PC 12 after bus line is plugged in. Namely, because the VPC 110 contains the USB 1.1/2.0 and IEEE 1394 controller 115 and cable plug-in detection function, the VPC 110 can be set as automatic connection or manual connection to the personal computer or other device. Therefore, the VPC 110 of FIG. 8 has ATAPI-IDE or Serial ATA interface (1141, 1141a) and USB 1.1/2.0 and IEEE 1394 controller 115 such that the VPC 110 can be employed internally or externally for the personal computer, such as Table Top PC, Notebook PC, or Tablet PC.

Further, in addition to having function of optical storage device in VPC 110, a function of mini-Hi Fi stereo can also be integrated into the VPC 110, such that an user may have both functions of optical storage and Hi-Fi stereo, so as to save space and cost for another Hi-Fi system. In other words, not only the VPC 110 performs a Hi-Fi stereo independently without any control through the computer interfaces, but can also perform a high performance optical storage device when connecting with the personal computer. Thus, when using the VPC 110 as a Hi-Fi stereo, there is unnecessary to turn on the personal computer and use the resources from the mother board or CPU of the personal computer.

Above described is a preferred embodiment of the invention which is not intended to limit the invention, simple change and modification without departing from the appended claims must be considered as falling within the scope of the invention.

| | |
|---|---|
| 1, 11 | Multi-functional optical disk driving device |
| 2, 12 | Personal computer (PC) |
| 10, 110 | Multi-functional vision process controller (VPC) |
| 11, 111 | PC power on status detector |
| 12, 112 | Microprocessor |
| 13, 113 | 40-pins bus switch |
| 113a | Serial bus switch |
| 14, 114 | Optical disk |
| 21, 121 | Power supply |
| 22 | Mother board of computer |
| 31 | Rear input |
| 32 | Rear output |
| 33 | FM antenna |
| 34 | DC 12 volts input |
| 35 | DVD-ROM CD-DA ANALOG AUDIO |
| | OUTPUT connector |
| 36 | SPDIF OUTPUT connector |
| 37 | DOMINATOR connector |
| 38 | POWER connector |
| 39 | AUDIO connector |
| 40 | IDE or SCSI connector |
| 41 | POWER connector |
| 115 | USB 1.1/2.0 and IEEE 1394 controller |
| 114, 221, 1141, 1221 | ATAPI-IDE (AT application program |
| | interface-integrated driving electronics) interface |
| 1141a, 1221a | Serial ATA interface |
| 1521 | USB 1.1/2.0 interface connector |
| 1521a | IEEE 1394 interface connector |

What is claimed is;

1. A multi-functional optical disk driving device, used for personal computer (PC), which has functions of a compact-disk (CD) driver, a digital versatile disk (DVD) driver, a frequency modulated (FM) radio, a MP3 music CD player, said device comprises: a multi-functional vision process controller (VPC) with a PC power on status detector, a microprocessor, an optical disk server; a bus switch, connected between standard interfaces of the PC and the optical disk server, and a microprocessor, for control of on/off of the bus switch, characterized in that said vision process controller (VPC) can disconnect the standard interfaces between said PC and said optical disk server by means of controlling the bus switch via said microprocessor when the PC is off, and the microprocessor performs the above functions independent; and said microprocessor controls said bus switch to connect the standard interfaces between said PC and said optical disk server when PC power on state is detected by the PC power on status detector, and the above functions are performed by said PC.

2. The multi-functional optical disk driving device as set forth in claim 1, in which said personal computer (PC) includes any one of Table Top PC, Notebook PC, and Tablet PC.

3. The multi-functional optical disk driving device as set forth in claim 1, in which said standard interfaces are an ATAPI-IDE or serial ATA, and USB 1.1/2.0 and IEEE 1394 standard interfaces the personal computer.

4. The multi-functional optical disk driving device as set forth in claim 1, in which said optical disk server includes any one of CD-ROM, DVD-ROM, DVD−R, DVD−RW, DVE+R, DVD+RW, and DVD-RAM servers.

5. The multi-functional optical disk driving device as set forth in claim 1, in which the functions of mode selection, adjustment control, and status indication are provided on a panel of said optical disk driving device.

6. The multi-functional optical disk driving device as set forth in claim 1, in which said PC power on status detector is used to detect the voltage of a power supply unit in the personal computer or the reset signal (HRST) of host computer received from a bus which is connected between said personal computer and the vision process controller so as to assure the power on status of the personal computer.

7. The multi-functional optical disk driving device as set forth in claim 1, further comprising a connecting device, said connecting device having a POWER connector, a DVD-ROM CD-DA ANALOG AUDIO OUTPUT connector, and a SPDIF (Sony-Philips Digital Interface) connector, wherein said connecting device includes a dominator connector, the dominator connector having a control bus and an output bus, by which the extensibility of the optical disk driving device can be increased.
